(19) United States
(12) Patent Application Publication
(10) Pub. No.: US 2017/0193987 A1
(43) Pub. Date: Jul. 6, 2017

(54) SPEECH RECOGNITION METHOD AND DEVICE

(71) Applicants: Le Holdings (Beijing) Co., Ltd., Beijing (CN); Le Shi Zhi Xin Electronic Technology (Tianjin) Limited, Binhai New Area (CN)

(72) Inventors: Yujun Wang, Binhai New Area (CN); Rui Hou, Binhai New Area (CN)

(21) Appl. No.: 15/240,119

(22) Filed: Aug. 18, 2016

Related U.S. Application Data
(63) Continuation of application No. PCT/CN2016/089579, filed on Jul. 10, 2016.

(30) Foreign Application Priority Data
Dec. 30, 2015 (CN) 201511027242.0

(51) Int. Cl. G10L 15/10; G10L 15/06; G10L 15/14; G10L 25/39

(52) U.S. Cl. CPC G10L 15/10; G10L 25/39; G10L 15/063; G10L 15/142; G10L 2015/0631

(57) ABSTRACT

This patent disclosure relates to a voice technology and discloses a voice recognition method and electronic device. In some embodiments of this disclosure, soft clustering calculation is performed in advance according to N gausses obtained by model training, to obtain M soft clustering gausses; when voice recognition is performed, voice is converted to obtain an eigenvector, and top L soft clustering gausses with highest scores are calculated according to the eigenvector, wherein the L is less than the M; and member gausses among the L soft clustering gausses are used as gausses that need to participate in calculation in an acoustic model in a voice recognition process to calculate likelihood of the acoustic model.

### CROSS-REFERENCE TO RELATED APPLICATIONS

The present disclosure is a continuation of PCT application No. PCT/CN2016/089579 submitted on Jul. 10, 2016. The present disclosure claims priority to Chinese Patent Application No. 201511027242.0, filed with the Chinese Patent Office on Dec. 30, 2015, which is incorporated herein by reference in its entirety.

### TECHNICAL FIELD

This patent disclosure relates to a voice technology, and in particular, to a voice recognition method and apparatus.

### BACKGROUND

The inventor finds in a process for implementing this disclosure that with development of a voice recognition technology, in recent years, precision of the voice recognition technology achieves great improvement with promotion of deep learning, especially in cloud-based services. Existing voice recognition services are mostly implemented in clouds. Voice need to be updated to a server, and the server performs acoustic evaluation on the uploaded voice, so as to provide a recognition result. In order to improve a recognition rate, servers mostly use a deep learning method to evaluate voice. However, deep learning requires great calculation resources and is not applicable in a local or embedded device. In addition, in many using scenarios in which networking cannot be performed, only a local voice recognition technology can be relied on. Because of limitation of local calculation and storage resources, a hidden Markov model (HMM) and a Gaussian Mixture Model (GMM) are still indispensable technical selections. This technical framework has the following advantages:

1. Controllable in a system size: a quantity of gausses in a Gaussian Mixture Model is easily controlled in training.

2. Controllable in a system speed: operation time can be greatly reduced by using the dynamic Gaussian selection technology.

The so-called Gaussian selection is that in a model training phase, all gausses in a voice recognition system are used as member gausses for clustering, to form clustering gausses; during recognition, acoustic characteristics are first used to evaluate each clustering gauss, and member gausses corresponding to clustering gausses with high likelihood are selected to be further evaluated. Other member gausses are abandoned. A traditional Gaussian selection technology has the following defects:

1. Hard clustering is used during clustering, that is, one member gauss only belongs to one clustering gauss. Clustering accuracy is relatively low.

2. During clustering, mean values and variances of member gausses are directly used as input of clustering; when the clustering gausses are trained, simple arithmetic mean is directly performed on the mean values and the variances, and clustering accuracy is extremely low.

3. During clustering, no effective iteration method causes clustering to be converged to local optimum.

4. During recognition, Gaussian selection cannot perform dynamic update, causing that excessive member gausses are reserved in calculation, and a recognition speed is low.

### SUMMARY

Embodiments of this disclosure provide a voice recognition method and an electronic device, which enables that a quantity of gausses that need to be evaluated in an acoustic model can be reduced in a voice recognition process and is more accurate and efficient than traditional Gaussian selection, to improve a speed and accuracy for evaluation of likelihood of an acoustic model.

According to a first aspect, an implementation manner of this disclosure provides a voice recognition method, including the following steps:

performing soft clustering calculation in advance according to N gausses obtained by model training, to obtain M soft clustering gausses;

when voice recognition is performed, converting voice to obtain an eigenvector and calculating top L soft clustering gausses with highest scores according to the eigenvector, where the L is less than the M; and

using member gausses among the L soft clustering gausses as gausses that need to participate in calculation in an acoustic model in a voice recognition process to calculate likelihood of the acoustic model.

According to a second aspect, an embodiment of this disclosure further provides a non-volatile computer storage medium, which stores a computer executable instruction, where the computer executable instruction is used to execute any foregoing voice recognition method of this disclosure.

According to a third aspect, an embodiment of this disclosure further provides an electronic device, including: at least one processor; and a memory, where the memory stores programs executable by the at least one processor, where execution of the instructions by the at least one processor causes the at least one processor to execute any foregoing voice recognition method of this disclosure.

In an implementation manner of this disclosure compared with the prior art, soft clustering calculation is performed on N gausses obtained by model training, to obtain M soft clustering gausses; the M soft clustering gausses are calculated according to an eigenvector to obtain top L soft clustering gausses with highest scores; and then acoustic model likelihood calculation is performed on member gausses among the L soft clustering gausses, to obtain a recognition output result. One member gauss may be made to belong to multiple clustering gausses by using soft clustering, which improves accuracy of clustering. In addition, during recognition, using a dynamic Gaussian selection manner reduces a quantity of gausses that need to be evaluated in an acoustic model in a recognition process, so that in a local recognition process, a score calculated amount of each member gauss in a GMM is lowered from 70% of a whole calculation time to 20%, improving a speed and precision for evaluation of acoustic model likelihood, especially applicable to local voice recognition, awakening, and voice endpoint detection (a start point for detecting voice).

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a schematic diagram of a voice recognition system according to some implementation manners of this disclosure;

FIG. 2 is a flowchart of calculation of soft clustering according to some implementation manners;

FIG. 3 is a flowchart of a voice recognition method according to some implementation manners;

FIG. 4 is a schematic diagram of dynamic Gaussian selection according to some implementation manners;

FIG. 5 is a schematic structural diagram of a voice recognition apparatus according to some implementation manners; and

FIG. 6 is a schematic structural diagram of an electronic device according to some implementation manners.

### DETAILED DESCRIPTION

To make the objectives, technical solutions, and advantages of this disclosure clearer, the following describes in detail the implementation manners of this disclosure with reference to the accompanying drawings. However, a person skilled in the art may understand that in the implementation manners of this disclosure, to make readers better understand this disclosure, many technical details are proposed. However, even if no technical details and various changes and modifications based on the following implementation manners are provided, the technical solutions of claims of this disclosure can also be implemented.

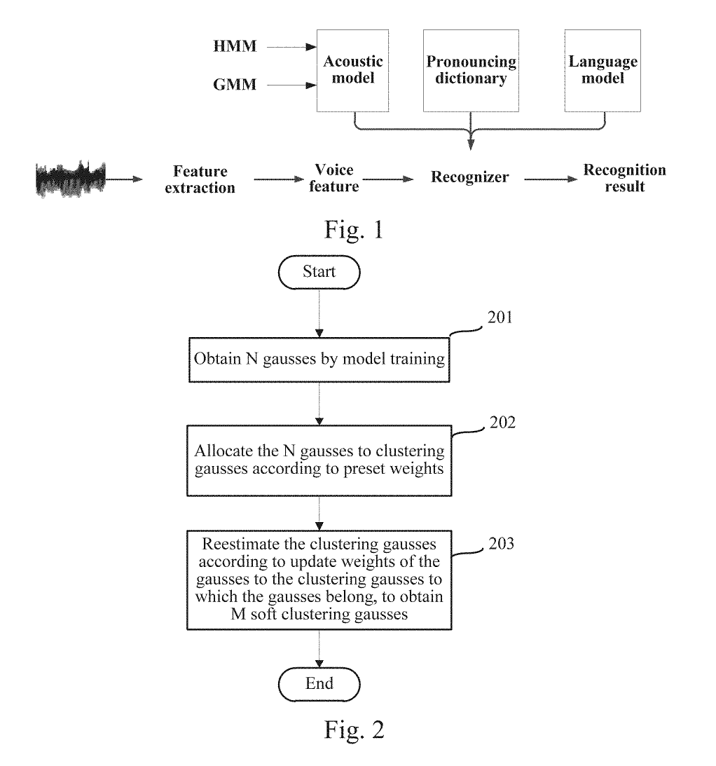

An objective of voice recognition is providing a most possible text when a voice signal is observed. As shown in FIG. 1, an HMM+GMM-based recognition system reads a segment of voice according to frames, and the system changes each frame of a voice signal into an eigenvector. The system evaluates likelihood of each gauss in an acoustic model with reference to each frame of the eigenvector. Besides, a combination of multiple words is assumed, likelihood evaluation is performed on the combination of these words by using a language model; a word combination with a greatest sum of acoustic likelihood and language likelihood is output as a recognition result.

A first implementation manner of this disclosure relates to a voice recognition method. In this implementation manner, soft clustering calculation needs to be performed in advance according to N gausses obtained by model training, to obtain M soft clustering gausses. When voice recognition is performed, a quantity of member gausses to be calculated is controlled in a dynamic Gaussian selection manner. In this implementation manner, a calculation process of soft clustering is shown in FIG. 2.

Step 201: Obtain N gausses by model training, such as obtaining 1000 gausses.

Step 202: Allocate the N gausses to clustering gausses according to preset weights.

Step 203: Reestimate the clustering gausses according to update weights of the gausses to the clustering gausses to which the gausses belong, to obtain M soft clustering gausses.

A person skilled in the art may understand that a Gaussian Mixture Model is used to describe a probability distribution of each state of a hidden Markov model (HMM) in voice recognition, and each state uses several gausses to state a probability distribution of itself. One Gaussian distribution has a mean value μ and a variance Σ of itself. To effectively use Gaussian selection in a recognition system, gausses need to be shared between states. An acoustic model for sharing gausses is called a semi-continuous Markov model. When gausses of the same quantity are used, a semi-continuous gauss improves a description capacity of a model, so as to improve a recognition rate. N (in a local recognition system, N is generally 1000) gausses are obtained by model training, and a distance criterion between gausses are necessarily clearly determined before clustering. In this implementation manner, a weighted symmetric KL divergence (WSKLD) is used as a distance criterion. An SKLD of a distance between a gauss m and a gauss n is:

SKLD(n,m)=½trace((Σₙ⁻¹+Σₘ⁻¹)(μₙ−μₘ)(μₙ−μₘ)′+Σₙ⁻¹Σₘ+ΣₙΣₘ⁻¹−2I).

Σₙ⁻¹ is a variance of the gauss n, Σₘ⁻¹ is a variance of the gauss m, μₙ is a mean value of the gauss n, and μₘ is a mean value of the gauss m. I is a unit matrix.

If the gauss model is divided into multiple sub-spaces, and each sub-space has its weight β, the WSKLD is:

$$WSKLD ( n , m ) = {\sum }_{j = 1}^{{N}_{strm}} {β}_{j} {SKLD}_{j} ( n , m )$$

Nₛₜᵣₘ is a quantity of sub-spaces of the gauss model.

Calculation of soft clustering may use any following algorithm in a specific implementation: a K mean value algorithm, a C mean value algorithm, and a self-organization map algorithm. Specific description is provided by using the K mean value algorithm as an example:

The algorithm may be described by using the following pseudo code:

1. a quantity of clustering gausses is set to 1, and all gausses are used as member gausses to estimate a clustering gauss.

2. while m<M (M is a target value of the quantity of the clustering gausses)

2a. find a clustering gauss ĵ, and the clustering gauss has a maximum WSKLD

2b. the gauss ĵ is split into two clustering gausses, m++

2c. For cycle τ from 1 to T

2c-1 For clustering gauss i, i from 1 to m

2c-1-1. For member gauss n, n from 1 to N, where N is a quantity of member gausses

An update contribution ĝ(i,n) of the member gauss to the i^{th} clustering gauss is calculated.

2c-1-2. Based on ĝ(i,n), a mean value μi and a variance Σi of the i^{th} clustering gauss is updated iteratively.

In the foregoing pseudo code, the target of clustering is making a clustering price Q minimum. A calculation formula of Q is as follows:

$$Q = {\sum }_{n = 1}^{N} ( {\sum }_{i = 1}^{m} g ( i , n ) WSKLD ( i , n ) + γ {\sum }_{m = 1}^{M} g ( i , n ) log \frac{1}{g ( i , n )} )$$

G(i, n) represents an update weight of the n^{th} gauss to the i^{th} clustering gauss, γ is a preset clustering hardness parameter, and WSKLD represents weighted symmetric KL divergence used as a distance criterion between gausses.

The following parameters may be obtained through iteration: mean values and variances of clustering gausses, and a weight of each member gauss to update of each clustering gauss:

$$[ {\hat{μ}}_{i} , \hat{{\sum }_{i}} , \hat{g} ( i , n ) ] = {argmin}_{{\sum }_{i = 1}^{M} g ( i , n ) = 1} ( Q )$$

In an iterative process of acquiring the foregoing parameter, the first step is acquiring an optimal update weight:

$$\hat{g} ( i , n ) = \frac{exp ( - WSKLD ( i , n ) / γ )}{{\sum }_{j = 1}^{m} exp ( - WSKLD ( j , n ) / γ )}$$

ĝ(i, n) is an update weight.

The second step is acquiring the optimal mean value and variance based on the optimal weight. A method for updating a mean value of a clustering gauss is as follows:

$${\hat{μ}}_{i} = {[ {\sum }_{n = 1}^{N} \hat{g} ( i , n ) ( {\sum }_{i}^{- 1} + {\sum }_{n}^{- 1} ) ]}^{- 1} [ {\sum }_{n = 1}^{N} \hat{g} ( i , n ) ( {\sum }_{i}^{- 1} + {\sum }_{n}^{- 1} ) {\hat{μ}}_{n} ]$$

To calculate a variance of the clustering gauss, an auxiliary matrix Z may be constructed.

$$Z = [ \begin{matrix}0 & {A}_{1} \\ {A}_{2} & 0\end{matrix} ]$$

$${A}_{1} = {\sum }_{n = 1}^{N} \hat{g} ( i , n ) [ ( {\hat{μ}}_{n} - {\hat{μ}}_{i} ) {( {\hat{μ}}_{n} - {\hat{μ}}_{i} )}^{′} + {\sum }_{i} ]$$

$${A}_{2} = {\sum }_{n = 1}^{N} \hat{g} ( i , n ) {\sum }_{i}^{- 1}$$

Based on a construction of Z, Z has DP positive eigenvalues and corresponding DP negative eigenvalues, where DP is dimension of mean values and variances. In this case, a matrix V of 2DP-by-DP is constructed and is an eigenvector corresponding to DP positive eigenvalues of Z. V is divided into an upper part U and a lower part W:

$$V = [ \begin{matrix}U \\ W\end{matrix} ]$$

Therefore, a covariance matrix of the clustering gauss is estimated as follows:

\hat{Σ}ᵢ=UW⁻¹

After the mean value and the covariance matrix are alternated and iterated for several rounds, the covariance matrix is limited as a diagonal matrix. This forced condition causes clustering not to be converged in few situations but does not influence clustering accuracy, so as to obtain reestimated clustering gausses as M soft clustering gausses.

That is, in this implementation manner, the recognition system calculates minimum clustering prices of clustering gausses, takes a derivative of each minimum clustering price, to acquire an update weight of each member gauss to each clustering gauss, and then calculates mean values and variances of the clustering gausses according to the update weight, to obtain estimated clustering gausses as M soft clustering gausses.

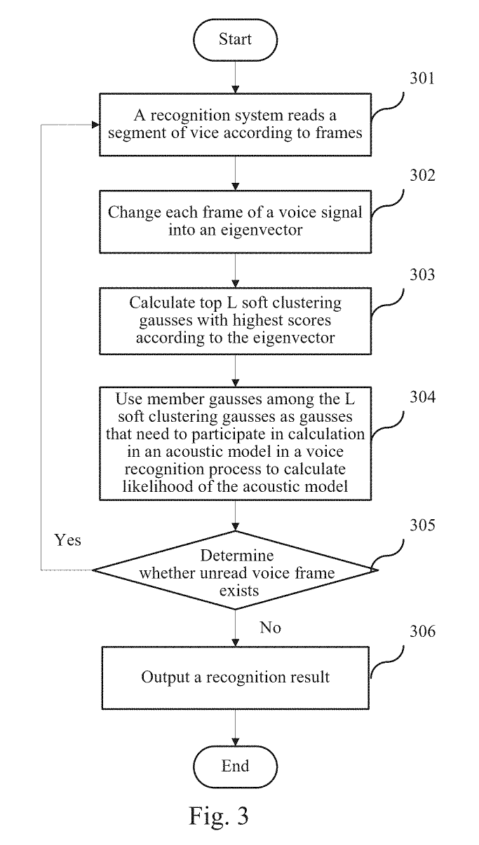

Voice is recognized after the M soft clustering gausses are obtained. A specific process is shown in FIG. 3:

Step 301: A recognition system reads a segment of vice according to frames. For example, a length of each frame is 10 ms.

Step 302: The recognition system changes each frame of a voice signal into an eigenvector, and the obtained eigenvector is used to evaluate a soft clustering gauss.

Step 303: Calculate top L soft clustering gausses with highest scores according to the eigenvector (L is less than M).

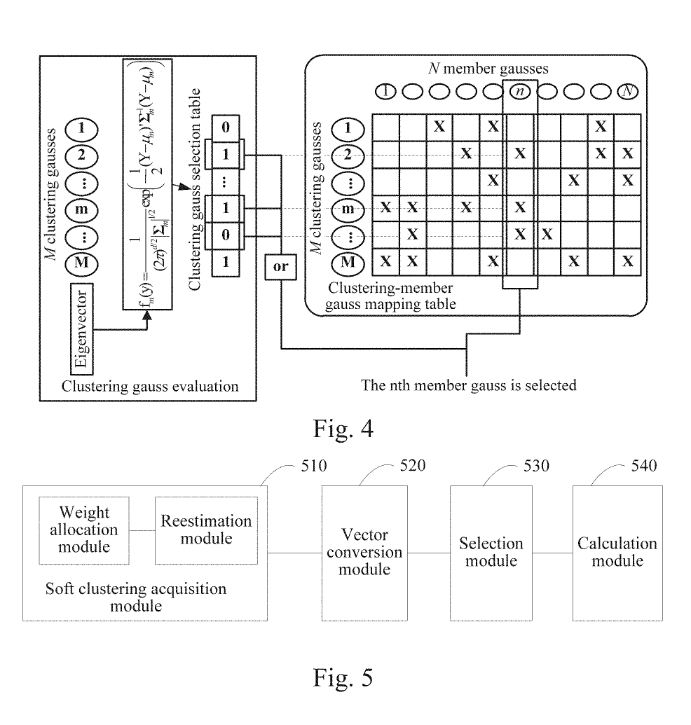

Specifically, as shown in FIG. 4, in a voice recognition process, after a segment of voice is converted into an eigenvector Y, all clustering gausses first use the vector for evaluation, and the top L soft clustering gausses with highest scores are selected and put in a clustering gauss selection table. Scores of soft clustering gausses may be acquired according to the following formula:

$${f}_{m} ( Y ) = \frac{1}{{( 2 π )}^{d / 2} {\vert {\sum }_{m} \vert}^{1 / 2}} exp ( - \frac{1}{2} {( Y - {μ}_{m} )}^{′} {\sum }_{m}^{- 1} ( Y - {μ}_{m} ) )$$

Y represents the eigenvector, μₘ represents a mean value of the m^{th} soft clustering gauss, Σₘ represents a variance of the m^{th} soft clustering gauss. After the scores of the M clustering gausses are obtained, top L clustering gausses with highest scores are used as selected clustering gausses.

In this implementation manner, a value of the L is a minimum value satisfying the following condition:

$${\sum }_{i = 1}^{L} {p ( {G}_{i} \vert Y )}^{α} > 0.95 {\sum }_{j = 1}^{M * 0.2} {p ( {G}_{j} \vert Y )}^{α}$$

where p(Gᵢ|Y)≧p(Gᵢ₊₁|Y)

Y represents the eigenvector, where α is a compression index for a “posterior” probability of a gauss, Gᵢ represents the i^{th} clustering gauss, and p(Gᵢ|Y) represents a “posterior” probability of the i^{th} clustering gauss.

Step 304: Use member gausses among the L soft clustering gausses as gausses that need to participate in calculation in an acoustic model in a voice recognition process to calculate likelihood of the acoustic model.

That is, whether one member gauss is selected and calculated depends on a member gauss-clustering gauss mapping table and a clustering gauss selection list. As shown in FIG. 4, in the clustering gauss selection table, “1” represents that the corresponding clustering gauss is selected at a current moment in a recognition process. A member gauss corresponding to the selected clustering gauss is queried in a “clustering-member gauss mapping table” and is calculated. Likelihood of unselected member gauss is replaced by a small value.

Step 305: Determine whether an unread voice frame exists. If a determining result is yes, it indicates a voice frame that needs to be recognized; return to step 301 to read a next voice frame and continue recognition. Otherwise, it indicates that voice recognition is completely finished; and end the process.

Step 306: Output a recognition result. Specifically, a voice recognition result in this step is a sum of acoustic likelihood and language likelihood. This step is the same as the prior art and is not described in detail herein.

To verify practicability of the voice recognition method in this implementation manner, on a test set, time and a recognition rate of several issued CPUs are tested, and a result is shown in FIG. 1:

Hard gauss clustering refers to that each member function only belongs to a clustering gauss, and clustering only uses a mean value as a vector. Soft accurate clustering is a method described in some embodiments of this disclosure. A gauss clustering system is not used as a base line. It can be seen that hard gauss clustering is worse than the method of some embodiments of this disclosure in accuracy. The above two have a same speed. A base line system is worse than some embodiments of this disclosure in speed and accuracy.

TABLE 1

| | | CPU time | | |
|---|---|---|---|---|
| | | Gauss | | |
| | | calculation | | Gauss |
| | Word | time | Decoding time | calculation |
| | error rate | (ms/frame) | (ms/frame) | percentage |
| Hard gauss | 7.02% | 1.4 | 6.1 | 17% |
| clustering | | | | |
| Soft accurate | 6.65% | 2.4 | 5.1 | 11% |
| clustering | | | | |
| Not using gauss | 6.87% | 15.3 | 6.7 | 100% |
| clustering | | | | |

It is not difficult to find that embodiments of this disclosure use an accurate K mean value (K-Means) method in a system training phase to perform soft clustering on gausses (that is, one member gauss may belong to multiple clustering gausses); a quantity of clusters gradually increases. In addition, each increasing manner reflects a rule for model distribution. During recognition, a quantity of member gausses to be calculated is controlled in a dynamic Gaussian selection manner, improving a speed and precision for evaluation of acoustic model likelihood, and being more accurate and efficient than traditional Gaussian selection.

A second implementation manner of this disclosure relates to a voice recognition method. The second implementation manner is roughly the same as the first implementation manner and mainly differs from the first implementation manner in that: in the first implementation manner, an accurate K mean value (K-Means) algorithm is used to perform soft clustering on gausses in a system training phase. In the second implementation manner of this disclosure, the C mean value algorithm is used to perform soft clustering on gausses in a system training phase. Because a specific implementation manner of using the C mean value algorithm to perform soft clustering is basically the same as the K mean value algorithm, it is not described in detail in this implementation manner.

A third implementation manner of this disclosure relates to a voice recognition method. The third implementation manner is roughly the same as the first implementation manner and mainly differs from the first implementation manner in that: in the first implementation manner, an accurate K mean value (K-Means) algorithm is used to perform soft clustering on gausses in a system training phase. In the third implementation manner of this disclosure, the self-organization map algorithm is used to perform soft clustering on gausses in a system training phase. Because a specific implementation manner of using the self-organization map algorithm to perform soft clustering calculation is only slightly different in step 203, and the self-organization map algorithm is a well-known technology of existing clustering algorithms, it is not described in detail in this implementation manner.

Step division of the above various methods is only used for clear description, and during implementation, steps can be combined into one step or some steps may be split into multiple steps. As long as steps include same logic relationship, they are within the protection scope of the present patent. Adding unrelated amendment in an algorithm or in a process or introducing unrelated design without changing a core design of the algorithm and process thereof all fall within the protection scope of the patent.

A fourth implementation manner of this disclosure relates to a voice recognition apparatus, as shown in FIG. 5, including:

a soft clustering acquisition module 510, configured to perform soft clustering calculation in advance according to N gausses obtained by model training, to obtain M soft clustering gausses;

a vector conversion module 520, configured to, when voice recognition is performed, convert voice to obtain an eigenvector;

a selection module 530, configured to calculate top L soft clustering gausses with highest scores according to the eigenvector and using member gausses among the top L soft clustering gausses as selected gausses, wherein the L is less than the M; and

a calculation module 540, configured to use the gausses selected by the selection module as gausses that need to participate in calculation in an acoustic model in a voice recognition process to calculate likelihood of the acoustic model.

The soft clustering acquisition module 510 includes:

a weight allocation module, configured to allocate the N gausses to clustering gausses according to preset weights; and

a reestimation module, configured to reestimate the clustering gausses according to update weights of gausses to the clustering gausses to which the gausses belong, to obtain the M soft clustering gausses.

It is not difficult to find that this implementation manner is a system embodiment corresponding to the first implementation manner, and this implementation manner may be implemented in a manner of cooperating with the implementation manner. Relevant technical details mentioned in the first implementation manner are still effective in this implementation manner, and in order to reduce repetition, are not described in detail herein. Correspondingly, relevant technical details mentioned in this implementation manner can also be applied to the first implementation manner.

It worth mentioning that modules involved in this implementation manner are all logic modules. In an actual application, one logic unit may be a physical unit or a part of one physical unit, or may be implemented as a combination of multiple physical units. In addition, in order to highlight the innovation part of this disclosure, this implementation manner does not introduce units that are not close to resolution of the technical problem relationship proposed in this disclosure, which does not indicate that other units do not exist in this implementation manner.

A fifth implementation manner of this disclosure relates to a non-volatile computer storage medium, which stores a computer executable instruction, where the computer executable instruction can execute the voice recognition method in any one of the foregoing method embodiments.

A sixth implementation manner of this disclosure relates to an electronic device. A schematic structural diagram of hardware is shown in FIG. 4. The device includes:

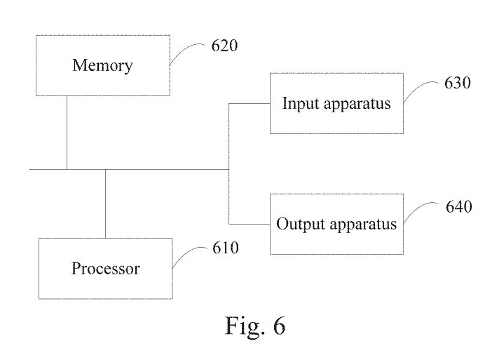

one or more processors 610 and a memory 620, where only one processor 610 is used as an example in FIG. 6.

The device of the voice recognition method may further include: an input apparatus 630 and an output apparatus 640.

The processor 610, the memory 620, the input apparatus 630, and the output apparatus 640 can be connected by means of a bus or in other manners. A connection by means of a bus is used as an example in FIG. 6.

As a non-volatile computer readable storage medium, the memory 620 can be used to store non-volatile software programs, non-volatile computer executable programs and modules, for example, a program instruction/module corresponding to the voice recognition method in the embodiments of this disclosure (for example, the soft clustering acquisition module 510, the vector conversion module 520, the selection module 530, and the calculation module 540). The processor 610 executes various functional applications and data processing of the server, that is, implements the resource searching method of the foregoing method embodiments, by running the non-volatile software programs, instructions, and modules that are stored in the memory 620.

The memory 620 may include a program storage area and a data storage area, where the program storage area may store an operating system and an application that is needed by at least one function; the data storage area may store data created according to use of the server, and the like. In addition, the memory 620 may include a high-speed random access memory, or may also include a non-volatile memory such as at least one disk storage device, flash storage device, or another non-volatile solid-state storage device. In some embodiments, the memory 620 optionally includes memories that are remotely disposed with respect to the processor 610, and the remote memories may be connected, via a network, to the server. Examples of the foregoing network include but are not limited to: the Internet, an intranet, a local area network, a mobile communications network, or a combination thereof.

The input apparatus 630 can receive entered digits or character information, and generate key signal inputs relevant to user setting and functional control of the server. The output apparatus 640 may include a display device, for example, a display screen.

The one or more modules are stored in the memory 620; when the one or more modules are executed by the one or more processors 610, the voice recognition method in any one of the foregoing method embodiments is executed.

The foregoing product can execute the method provided in the embodiments of this disclosure, and has corresponding functional modules for executing the method and beneficial effects. Refer to the method provided in the embodiments of this disclosure for technical details that are not described in detail in this embodiment.

The electronic device in this embodiment of this disclosure exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this disclosure, rather than limit this disclosure. Although this disclosure is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this disclosure.

1. A voice recognition method, applied to a terminal, comprising the following steps:
performing soft clustering calculation in advance according to N gausses obtained by model training, to obtain M soft clustering gausses;
when voice recognition is performed, converting voice to obtain an eigenvector and calculating top L soft clustering gausses with highest scores according to the eigenvector, wherein the L is less than the M; and
using member gausses among the L soft clustering gausses as gausses that need to participate in calculation in an acoustic model in a voice recognition process to calculate likelihood of the acoustic model.

2. The voice recognition method according to claim 1, wherein the step of performing soft clustering calculation according to N gausses obtained by model training comprises the following sub-steps:
allocating the N gausses to clustering gausses according to preset weights; and
reestimating the clustering gausses according to update weights of the gausses to the clustering gausses to which the gausses belong, to obtain the M soft clustering gausses.

3. The voice recognition method according to claim 1, wherein in the step of performing soft clustering calculation according to N gausses obtained by model training, any following algorithm is used to calculate the soft clustering:
a K mean value algorithm, a C mean value algorithm, and a self-organization map algorithm.

4. The voice recognition method according to claim 3, comprising:
calculating a minimum clustering price of the clustering gausses when the K mean value algorithm is used to reestimate the clustering gausses;
taking a derivative of the minimum clustering price and acquiring an update weight of each member gauss to each clustering gauss;
calculating mean values and variances of the clustering gausses according to the acquired update weight of each member gauss to each clustering gauss, to obtain the reestimated clustering gausses; and
using the estimated clustering gausses as the M soft clustering gausses.

5. The voice recognition method according to claim 4, wherein the minimum clustering price Q is calculated according to the following formula:
$$Q = {\sum }_{n = 1}^{N} ( {\sum }_{i = 1}^{m} g ( i , n ) WSKLD ( i , n ) + γ {\sum }_{m = 1}^{M} g ( i , n ) log \frac{1}{g ( i , n )} )$$
wherein g(i, n) represents an update weight of the n^{th} gauss to the i^{th} clustering gauss, γ is a preset clustering hardness parameter, and WSKLD represents weighted symmetric KL divergence used as a distance criterion between gausses.

6. The voice recognition method according to claim 1, wherein a value of the L is a minimum value satisfying the following condition:
$${\sum }_{i = 1}^{L} {p ( {G}_{i} \vert Y )}^{α} > 0.95 {\sum }_{j = 1}^{M * 0.2} {p ( {G}_{j} \vert Y )}^{α}$$
wherein p(Gᵢ|Y)≧p(Gᵢ₊₁|Y)
the Y represents the eigenvector, wherein α is a compression index for a posterior probability of a gauss, Gᵢ represents the i^{th} clustering gauss, and p(Gᵢ|Y) represents a posterior probability of the i^{th} clustering gauss.

7. The voice recognition method according to claim 1, wherein the step of calculating top L soft clustering gausses with highest scores according to the eigenvector comprises the following sub-steps:
acquiring scores of soft clustering gausses according to the following formula:
$${f}_{m} ( Y ) = \frac{1}{{( 2 π )}^{d / 2} {\vert {\sum }_{m} \vert}^{1 / 2}} exp ( - \frac{1}{2} {( Y - {μ}_{m} )}^{′} {\sum }_{m}^{- 1} ( Y - {μ}_{m} ) )$$
wherein the Y represents the eigenvector, μₘ represents a mean value of the m^{th} soft clustering gauss, and Σₘ represents a variance of the m^{th} soft clustering gauss.

8. The voice recognition method according to claim 1, wherein in the step of converting voice to obtain an eigenvector, each voice frame is converted into the eigenvector.

9-10. (canceled)

11. A non-volatile computer storage medium, which stores a computer executable instruction, that when executed by an electronic device, cause the electronic device to:
perform soft clustering calculation in advance according to N gausses obtained by model training, to obtain M soft clustering gausses;
when voice recognition is performed, convert voice to obtain an eigenvector and calculating top L soft clustering gausses with highest scores according to the eigenvector, wherein L is less than M; and
use member gausses among the L soft clustering gausses as gausses that need to participate in calculation in an acoustic model in a voice recognition process to calculate likelihood of the acoustic model.

12. The non-volatile computer storage medium according to claim 11, wherein the instructions to perform soft clustering calculation according to N gausses obtained by model training cause the electronic device to:
allocate the N gausses to a clustering gauss according to preset weights; and
reestimate the clustering gausses according to update weights of gausses to the clustering gausses to which the gausses belong, to obtain the M soft clustering gausses.

13. The non-volatile computer storage medium according to claim 11, wherein the instructions to perform soft clustering calculation according to N gausses obtained by model training, any following algorithm is used to calculate the soft clustering:
a K mean value algorithm, a C mean value algorithm, and a self-organization map algorithm.

14. The non-volatile computer storage medium according to claim 13, wherein
a minimum clustering price of the clustering gausses is calculated when the K mean value algorithm is used to reestimate the clustering gausses;
a derivative of the minimum clustering price is taken and an update weight of each member gauss to each clustering gauss is acquired;
mean values and variances of the clustering gausses are calculated according to the acquired update weight of each member gauss to each clustering gauss, to obtain the reestimated clustering gausses; and
the estimated clustering gausses are used as the M soft clustering gausses.

15. The non-volatile computer storage medium according to claim 14, wherein the minimum clustering price Q is calculated according to the following formula:
$$Q = {\sum }_{n = 1}^{N} ( {\sum }_{i = 1}^{m} g ( i , n ) WSKLD ( i , n ) + γ {\sum }_{m = 1}^{M} g ( i , n ) log \frac{1}{g ( i , n )} )$$
wherein g(i, n) represents an update weight of the n^{th} gauss to the i^{th} clustering gauss, γ is a preset clustering hardness parameter, and WSKLD represents weighted symmetric KL divergence used as a distance criterion between gausses.

16. The non-volatile computer storage medium according to claim 11, wherein a value of the L is a minimum value satisfying the following condition:
$${\sum }_{i = 1}^{L} {p ( {G}_{i} \vert Y )}^{α} > 0.95 {\sum }_{j = 1}^{M * 0.2} {p ( {G}_{j} \vert Y )}^{α}$$
wherein p(Gᵢ|Y)≧p(Gᵢ₊₁|Y)
the Y represents the eigenvector, wherein α is a compression index for a posterior probability of a gauss, Gᵢ represents the i^{th} clustering gauss, and p(Gᵢ|Y) represents a posterior probability of the i^{th} clustering gauss.

17. An electronic device, comprising:
at least one processor; and
a memory communicably connected with the at least one processor, wherein
the memory stores instructions executable by the at least one processor, wherein execution of the instructions by the at least one processor causes the at least one processor to:
perform soft clustering calculation in advance according to N gausses obtained by model training, to obtain M soft clustering gausses;
when voice recognition is performed, convert voice to obtain an eigenvector and calculating top L soft clustering gausses with highest scores according to the eigenvector, wherein L is less than M; and
use member gausses among the L soft clustering gausses as gausses that need to participate in calculation in an acoustic model in a voice recognition process to calculate likelihood of the acoustic model.

18. The electronic device according to claim 17, wherein the execution of the instructions to perform soft clustering calculation according to N gausses obtained by model training cause the at least one processor to:
allocate the N gausses to a clustering gauss according to preset weights; and
reestimate the clustering gausses according to update weights of gausses to the clustering gausses to which the gausses belong, to obtain the M soft clustering gausses.

19. The electronic device according to claim 17, wherein in the step of performing soft clustering calculation according to N gausses obtained by model training, any following algorithm is used to calculate the soft clustering:
a K mean value algorithm, a C mean value algorithm, and a self-organization map algorithm.

20. The electronic device according to claim 19, wherein
a minimum clustering price of the clustering gausses is calculated when the K mean value algorithm is used to reestimate the clustering gausses;
a derivative of the minimum clustering price is taken and an update weight of each member gauss to each clustering gauss is acquired;
mean values and variances of the clustering gausses are calculated according to the acquired update weight of each member gauss to each clustering gauss, to obtain the reestimated clustering gausses; and
the estimated clustering gausses are used as the M soft clustering gausses.

21. The electronic device according to claim 20, wherein the minimum clustering price Q is calculated according to the following formula:
$$Q = {\sum }_{n = 1}^{N} ( {\sum }_{i = 1}^{m} g ( i , n ) WSKLD ( i , n ) + γ {\sum }_{m = 1}^{M} g ( i , n ) log \frac{1}{g ( i , n )} )$$
wherein g(i, n) represents an update weight of the n^{th} gauss to the i^{th} clustering gauss, γ is a preset clustering hardness parameter, and WSKLD represents weighted symmetric KL divergence used as a distance criterion between gausses.

22. The electronic device according to claim 17, wherein a value of the L is a minimum value satisfying the following condition:
$${\sum }_{i = 1}^{L} {p ( {G}_{i} \vert Y )}^{α} > 0.95 {\sum }_{j = 1}^{M * 0.2} {p ( {G}_{j} \vert Y )}^{α}$$
wherein p(Gᵢ|Y)≧p(Gᵢ₊₁|Y)
the Y represents the eigenvector, wherein α is a compression index for a posterior probability of a gauss, Gᵢ represents the i^{th} clustering gauss, and p(Gᵢ|Y) represents a posterior probability of the i^{th} clustering gauss.
